(19) United States
(12) Patent Application Publication
(10) Pub. No.: US 2026/0252832 A1
(43) Pub. Date: Aug. 27, 2026

(54) Hand-Held RFID Reader with One or More Imaging Assemblies

(71) Applicant: Zebra Technologies Corporation, Lincolnshire, IL (US)

(72) Inventors: Yuri Astvatsaturov, Lake Forest, IL (US); David Bellows, Fort Salonga, NY (US)

(73) Assignee: Zebra Technologies Corporation, Lincolnshire, IL (US)

(21) Appl. No.: 19/065,943

(22) Filed: Feb. 27, 2025

(51) Int. Cl. G06K 7/10

(52) U.S. Cl. CPC G06K 7/10386; G06K 7/10376; G06K 7/10405; G06K 2007/10485; G06K 2007/10524

(57) ABSTRACT

An example hand-held radio-frequency identification (RFID) reader with one or more imaging assemblies for reading RFID tags includes a housing having a top portion, a front portion, and a handle extending from the top portion of the housing. An RFID antenna is positioned within the front portion of the housing, a first imaging assembly is positioned on a first side of the RFID antenna and distal to the top portion of the housing, and a second imaging assembly is positioned on a second side of the RFID antenna, opposite the first side, and proximal the top portion of the housing. The first imaging assembly has a first field-of-view (FOV) directed through a first window in the front portion of the housing and the second imaging assembly has a second FOV directed through a second window in the front portion of the housing.

### BACKGROUND

Typical hand-held accessories, devices, and systems for reading radio-frequency identification (RFID) tags have a construction that includes an RFID antenna dome that can limit the field-of-view (FOV) of the imaging components positioned in the top portion of the accessory/device. Additionally, a display of a mobile device that may be coupled to the accessory or be part of the system or a display of the device may be positioned such that the operator is required to consistently tilt the reader between image capture operations and reviewing/entering data on the display.

### SUMMARY

In an embodiment, the present invention is a hand-held accessory for reading RFID tags, comprising a housing including a top portion, a front portion, and a handle. The front portion has a first window and a second window and the handle extends from the top portion of the housing. An RFID antenna is positioned within the front portion of the housing. A first imaging assembly is positioned on a first side of the RFID antenna and distal to the top portion of the housing, and has a first field-of-view (FOV) directed through the first window. A second imaging assembly is positioned on a second side of the RFID antenna, which is opposed to the first side, and proximal to the top portion of the housing, and has a second FOV directed through the second window.

In a variation of this embodiment, the hand-held accessory comprises a mounting adapter removably mounted to a top surface of the housing and configured to receive a mobile computing device.

In another variation of this embodiment, the first FOV and the second FOV at least partially overlap.

In another variation of this embodiment, a first centerline of the first FOV extends non-parallel to a longitudinal axis of the housing and in a direction away from a top surface of the housing and a second centerline of the second FOV extends parallel to the longitudinal axis of the housing.

In another variation of this embodiment, the hand-held accessory comprises an accelerometer positioned within the housing and configured to detect an angular orientation of the housing.

In another variation of this embodiment, the hand-held accessory comprises a controller in communication with the first imaging assembly, the second imaging assembly, and the accelerometer. The controller is configured to activate at least one of the first imaging assembly and/or the second imaging assembly based on the angular orientation of the housing.

In another variation of this embodiment, the controller is configured to: responsive to the angular orientation of the housing indicating that the hand-held accessory is pointed in a downward direction relative to horizontal, activating at least the second imaging assembly; and responsive to the angular orientation of the housing indicating that the hand-held accessory is pointed in an upward direction relative to horizontal, activating at least the first imaging assembly.

In another variation of this embodiment, the RFID antenna is configured to avoid interference from the first imaging assembly.

In another embodiment, the present invention is a system for reading RFID tags, comprising a housing including a top portion, a front portion, and a handle. The front portion of the housing has a first window and the handle extends from the top portion of the housing. An RFID antenna is positioned within the front portion of the housing. A first imaging assembly is positioned on a first side of the RFID antenna and distal to the top portion of the housing and has a first FOV directed through the first window. A mobile computing device is removably mounted to the housing and comprises a second window and second imaging assembly having a second FOV directed through the second window. The second imaging assembly is located on a second side of the RFID antenna, opposite the first side, with the mobile computing device mounted to the housing.

In a variation of this embodiment, the mobile computing device includes a display.

In another variation of this embodiment, the display is oriented substantially parallel to a top surface of the housing with the mobile computing device mounted to the housing.

In another variation of this embodiment, a mounting adapter is removably mounted to a top surface of the housing and is configured to receive the mobile computing device.

In another variation of this embodiment, the first FOV and the second FOV at least partially overlap.

In another variation of this embodiment, a first centerline of the first FOV extends non-parallel to a longitudinal axis of the housing and in a direction away from a top surface of the housing and a second centerline of the second FOV extends parallel to the longitudinal axis of the housing.

In another variation of this embodiment, the system comprises an accelerometer positioned within the housing and configured to detect an angular orientation of the housing.

In another variation of this embodiment, the system comprises a controller in communication with the first imaging assembly, the second imaging assembly, and the accelerometer. The controller is configured to activate at least one of the first imaging assembly and/or the second imaging assembly based on the angular orientation of the housing.

In another variation of this embodiment, the controller is configured to: responsive to the angular orientation of the housing indicating that the system is pointed in a downward direction relative to horizontal, activating at least the second imaging assembly; and responsive to the angular orientation of the housing indicating that the system is pointed in an upward direction relative to horizontal, activating at least the first imaging assembly.

In another variation of this embodiment, the RFID antenna is configured to avoid interference from the first imaging assembly.

In another embodiment, the present invention is a hand-held accessory for reading RFID tags, comprising a housing including a top portion, a front portion, and a handle. The front portion has a first window, the top portion has a top surface configured to receive a mobile computing device, and the handle extends from the top portion of the housing. An RFID antenna is positioned within the front portion of the housing. A first imaging assembly is positioned on a first side of the RFID antenna, opposite the top surface of the housing, and distal to the top portion of the housing and has a first FOV directed through the first window.

In a variation of this embodiment, the hand-held accessory comprises a mounting adapter removably mounted to the top surface of the housing and configured to receive the mobile computing device.

In another variation of this embodiment, a first centerline of the first FOV extends non-parallel to a longitudinal axis of the housing and in a direction away from the top surface of the housing.

In another variation of this embodiment, the hand-held accessory comprises an accelerometer positioned within the housing and configured to detect an angular orientation of the housing.

In another variation of this embodiment, the hand-held accessory comprises a controller in communication with the first imaging assembly and the accelerometer. The controller is configured to activate the first imaging assembly based on the angular orientation of the housing.

In another variation of this embodiment, the controller is configured to: responsive to the angular orientation of the housing indicating that the hand-held accessory is pointed in an upward direction relative to horizontal, activating at least the first imaging assembly.

In another variation of this embodiment, the RFID antenna is configured to avoid interference from the first imaging assembly.

In another embodiment, the present invention is a hand-held device for reading radio-frequency identification (RFID) tags, comprising a housing including top portion, a front portion, and a handle. The front portion has a first window and a second window, the handle extends from the top portion, and an input-output device is positioned at least partially within the housing. An RFID antenna is positioned within the front portion of the housing. A first imaging assembly is positioned on a first side of the RFID antenna and distal to the top portion of the housing and has a first field-of-view (FOV) directed through the first window. A second imaging assembly is positioned on a second side of the RFID antenna and proximal the top portion of the housing, the first side being opposed to the second side, and has a second FOV directed through the second window.

In a variation of this embodiment, the input-output device is at least partially positioned in the top portion of the housing.

In another variation of this embodiment, the input-output device comprises a touchscreen.

In another variation of this embodiment, the input-output device comprises a display and a keyboard.

In another variation of this embodiment, the first FOV and the second FOV at least partially overlap.

In another variation of this embodiment, a first centerline of the first FOV extends non-parallel to a longitudinal axis of the housing and in a direction away from a top surface of the housing and a second centerline of the second FOV extends parallel to the longitudinal axis of the housing.

In another variation of this embodiment, the hand-held device comprises an accelerometer positioned within the housing and configured to detect an angular orientation of the housing.

In another variation of this embodiment, the hand-held device comprises a controller in communication with the first imaging assembly, the second imaging assembly, the input-output device and the accelerometer. The controller is configured to activate at least one of the first imaging assembly and/or the second imaging assembly based on the angular orientation of the housing.

In another variation of this embodiment, the controller is configured to: responsive to the angular orientation of the housing indicating that the hand-held device is pointed in a downward direction relative to horizontal, activate at least the second imaging assembly; and responsive to the angular orientation of the housing indicating that the hand-held device is pointed in an upward direction relative to horizontal, activate at least the first imaging assembly.

In another variation of this embodiment, the RFID antenna is configured to avoid interference from the first imaging assembly

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a perspective view of a first example of a hand-held accessory for reading RFID tags;

FIG. 2 illustrates a side view of the hand-held accessory of FIG. 1;

FIG. 3 illustrates a front view of the hand-held accessory of FIG. 1;

FIG. 4 illustrates a perspective view of the hand-held accessory of FIG. 1 with a mounting adapter and a mobile computing device;

FIG. 5 illustrates a perspective view of an example of a system for reading RFID tags;

FIG. 6 illustrates a side view of the system of FIG. 5;

FIG. 7 illustrates a front view of the system of FIG. 5;

FIG. 8 illustrates a perspective view of a second example of a hand-held accessory for reading RFID tags;

FIG. 9 illustrates a side view of the hand-held accessory of FIG. 8;

FIG. 10 illustrates a front view of the hand-held accessory of FIG. 8;

FIG. 11 illustrates a perspective view of an example of a hand-held device for reading RFID tags;

FIG. 12 illustrates a side view of the hand-held device of FIG. 11;

FIG. 13 illustrates a front view of the hand-held device of FIG. 11; and

FIG. 14 illustrates a top view of the hand-held device of FIG. 11.

Skilled artisans will appreciate that elements in the figures are illustrated for simplicity and clarity, have not necessarily been drawn to scale, and that details that are not necessary for an understanding of the invention or that render other details difficult to perceive may be omitted. For example, the dimensions of some of the elements in the figures may be exaggerated relative to other elements to help to improve understanding of embodiments of the present invention.

The apparatus components have been represented where appropriate by conventional symbols in the drawings, showing only those components and specific details that are pertinent to understanding the examples of the present invention so as not to obscure the disclosure with details that will be readily apparent to those of ordinary skill in the art having the benefit of the description herein.

### DETAILED DESCRIPTION

The example hand-held accessories/devices/systems for reading radio-frequency identification (RFID) tags position an imaging assembly below the RFID antenna (e.g., at the bottom portion of the antenna dome). This configuration can provide several benefits when compared to the placement of imaging assemblies in typical accessories/devices/systems. For example, this configuration can allow for objects placed at a close-in distance and mainly below the RFID antenna to be scanned with greater ease. For example, a user may need to scan a pallet bar code near the floor while RFID scanning the contents on the pallet. With the imaging assembly placed at the bottom of the antenna dome, the field-of-view (FOV) of the imaging assembly is not obstructed by the antenna dome itself.

In addition, the accessory/device/system may be configured such that when it is tilted toward the user (e.g., for viewing of a display on a mobile computing device coupled to the accessory or part of the system or a display on the device), the camera below the RFID antenna can be activated, giving the user the ability to capture image data while viewing the display. This is useful with a user needing to look at the display often to help frame the desired image, requiring the user to tilt the accessory/device/system back. The position of the imaging assembly below the RFID antenna puts the imaging assembly in a more optimal orientation for aiming in the proper direction when the user views the display. When tilted back, the FOV of the imaging assembly below the RFID antenna can approximate the FOV of an imaging assembly above the RFID antenna when the accessory/device/system is not tilted back so that the user can effectively have the same experience in either scenario.

Furthermore, the accessory/device/system can have an accelerometer that can be used to detect the angle at which the accessory/device/system is oriented, thereby enabling the accessory/device/system to dynamically select the imaging assembly that would be more appropriate to utilize.

There may also be implementations where only an imaging assembly below the RFID antenna is necessary. This allows for the RFID antenna to be positioned closer to the main electronics stack and therefore closer to the RFID radio. This shorter separation results in a lower loss connection, which is another benefit of positioning an imaging assembly below the RFID antenna.

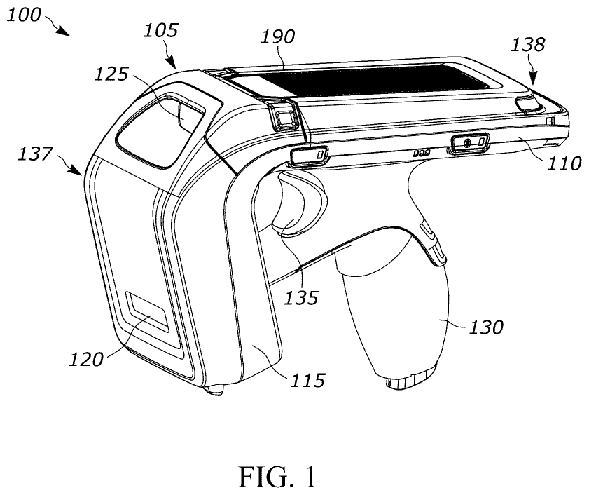

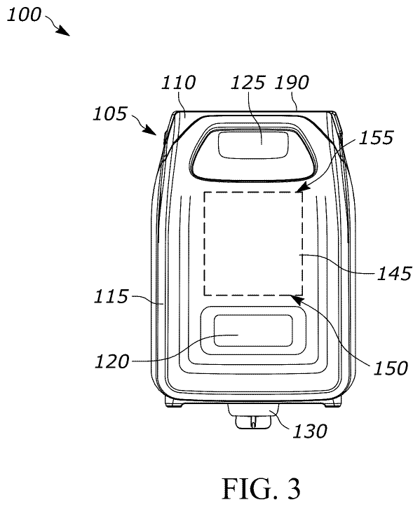

Referring to FIGS. 1-4, a first example of a hand-held accessory 100 for reading RFID tags is illustrated. As used herein, the term hand-held accessory may include, but is not limited to, a stand-alone device; a device used in conjunction with one or more devices; or any suitable device. In the example shown, hand-held accessory 100 generally includes a housing 105, which includes a top portion 110, a front portion 115 (e.g., an antenna dome, a.k.a. radome), and a handle 130 that extends from top portion 110. Front portion 115 can extend in a downward direction from top portion 110 (e.g., in the same direction as handle 130) and an RFID antenna 145 is positioned within front portion 115. Handle 130 is configured to be grasped by a user of hand-held accessory 100 and can include a trigger 135, which can be used to activate RFID antenna 145 and/or one or more imaging assemblies associated with the hand-held accessory 100.

Hand-held accessory 100 also includes a first imaging assembly 160 and a second imaging assembly 175. First imaging assembly 160 is positioned on a first side 150 of RFID antenna 145 and distal to top portion 110 of housing 105 and has a first FOV 165 that is directed through a first window 120 in front portion 115 of housing 105. Second imaging assembly 175 is positioned on a second side 155 of RFID antenna 145, opposite first side 150, and proximal top portion 110 of housing 105 and has a second FOV 180 that is directed through a second window 125 in front portion 115 of housing 105.

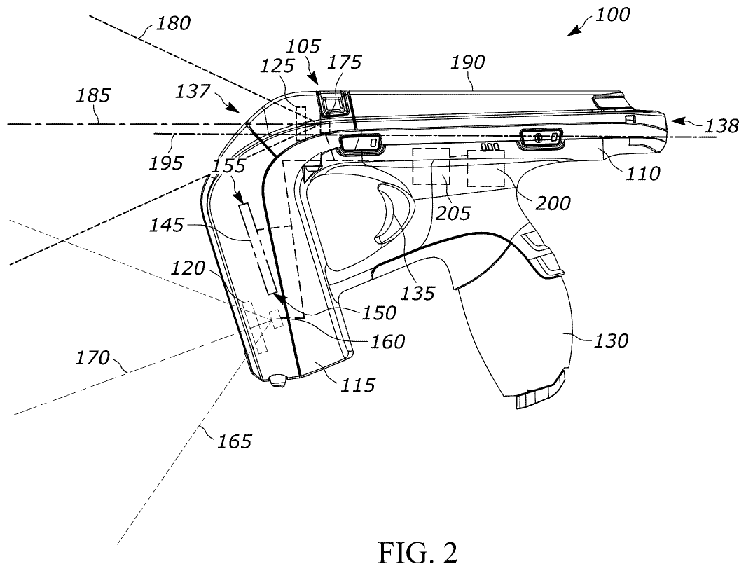

In the example shown, first FOV 165 has a first centerline 170 that, in some embodiments, extends non-parallel to a longitudinal axis 195 of housing 105 and in a direction away from a top surface 190 of housing 105 (e.g., downward in the orientation shown in FIG. 2) and second FOV 180 can have a second centerline 185 that, in some embodiments, extends generally parallel to longitudinal axis 195 of housing 105. With first FOV 165 and second FOV 180 oriented in this manner, second FOV 180 can capture image data of objects generally aligned along longitudinal axis 195 of housing 105 and above RFID antenna 145 and first FOV 165 can capture image data of objects generally below RFID antenna 145 (e.g., a barcode located below an RFID tag or an object directly in front of hand-held accessory 100 with hand-held accessory 100 tilted in an upward direction). Additional configurations of first FOV 165 and second FOV 180 are also possible. For example, first FOV 165 and second FOV 180 can partially overlap at a predetermined distance in front of housing 105, first FOV 165 can be configured to overlap or encompass a radiation pattern (not shown) of RFID antenna 145, the centerlines may be oriented in any desired direction, etc.

In implementations where first imaging assembly 160 is positioned proximate to RFID antenna 145, RFID antenna 145 may be designed in a manner that takes this adjacency into account to mitigate potential negative effect on the functional performance of RFID antenna 145. For example, the presence of first imaging assembly 160 may otherwise alter the resonant frequency, bandwidth, impedance, radiation pattern, gain, and/or directivity of RFID antenna 145. In a further example, the presence of first imaging assembly 160 may act as a capacitive load or an inductive load to RFID antenna 145, thereby shifting the resonant frequency of RFID antenna 145. As such, understanding that the elements of the immediate environment surrounding RFID antenna 145 may affect RFID antenna 145, the physical design of RFID antenna 145 can compensate for these loads by, for example, tailoring the geometry of physical features of an element(s) of the antenna (e.g., by lengthening or shortening) to optimally match the radiating frequency of RFID antenna 145 to the desired RFID band (i.e., tuning). For example, if it is known that the presence of a relatively close first imaging assembly 160 would pull the resonant frequency of RFID antenna 145 down, RFID antenna 145 may be designed with a shorter radiating element to counter this effect and bring the resonant frequency back up so that it is in the desired band. In another example, if it is known that the presence of first imaging assembly 160 below RFID antenna 145 pulls the radiation pattern of RFID antenna 145 downward, RFID antenna 145 and/or its immediate environment may include another conductive feature on the opposite side (e.g., second side 155) that counters this effect and pulls the radiation pattern back upward to center it. Furthermore, electrical connections directed to first imaging assembly 160 may be run in relatively close proximity to RFID antenna 145, and RFID antenna 145 can be configured to avoid interference from first imaging assembly 160. For example, RFID antenna 145 can be positioned and oriented within front portion 115 of housing 105 such that a communications bus connecting first imaging assembly 160 to other components of hand-held accessory 100 is located behind a ground plane of RFID antenna 145, where the communications bus can be effectively shielded from negatively affecting the performance of RFID antenna 145. Conversely, shielding the communications bus behind an antenna ground plane may also prevent RFID antenna 145 from interfering with the communications bus as well. In other embodiments, the communications bus may be treated as being in relatively close proximity to RFID antenna 145, and as such, RFID antenna 145 may be designed to take this into account as described earlier in order to mitigate any potential negative effect on the functional performance of RFID antenna 145.

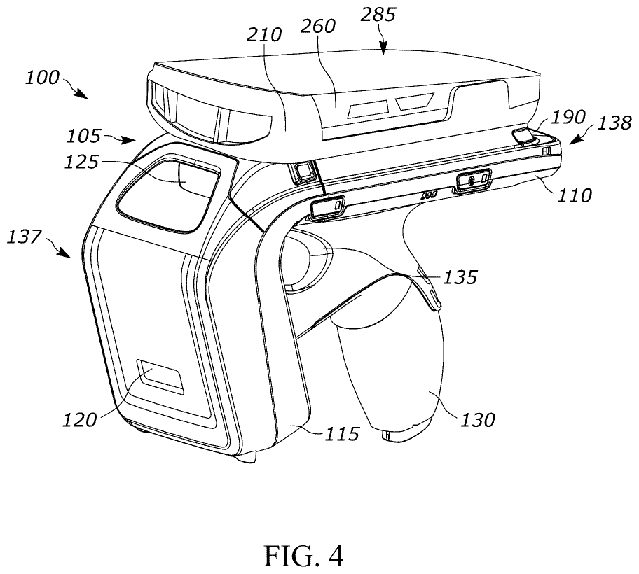

Referring specifically to FIG. 4, in some implementations, hand-held accessory 100 can also include a mounting adapter 210 that is configured to receive a mobile computing device 260, for example, a smart phone or other type of mobile computer, which can have a processor, a memory, a display, an input device, etc. In the implementation shown, mounting adapter 210 is removably mounted to a top surface 190 of housing 105, for example, via spring arms on mounting adapter 210 that can engage a portion of housing 105, threaded members that can be threaded through mounting adapter 210 and into housing 105, a hook and loop type fastener located between mounting adapter 210 and housing 105, etc. In other implementations, mounting adapter 210 may not be a separate part and can be an integral and unitary part of housing 105.

As shown in the example in FIG. 2, hand-held accessory 100 can also include an accelerometer 200 positioned within housing 105 and configured to detect an angular orientation of housing 105. Hand-held accessory 100 can also include a controller 205, which can include a processor and memory, that is in communication with accelerometer 200, first imaging assembly 160, and second imaging assembly 175. In some implementations, controller 205 can be configured to activate at least one of first imaging assembly 160 and/or second imaging assembly 175 based on the angular orientation of housing 105. For example, in response to the angular orientation of housing 105 indicating that hand-held accessory 100 is generally level or pointed in a downward direction relative to horizontal (e.g., as detected by accelerometer 200), controller 205 can be configured to activate second imaging assembly 175. Similarly, in response to the angular orientation of housing 105 indicating that hand-held accessory 100 is pointed in an upward direction relative to horizontal (e.g., as detected by accelerometer 200), controller 205 can be configured to activate first imaging assembly 160. As used herein, pointed in a downward direction relative to horizontal means that a first end 137 of housing 105, proximate front portion 115, is lower than a second end 138 of housing 105, distal from front portion 115. In addition, pointed in an upward direction relative to horizontal means that first end 137 is higher than second end 138, such as with hand-held accessory 100 tilted such that a user of hand-held accessory 100 can view a display 285 of mobile computing device 260 with mobile computing device 260 mounted to housing 105.

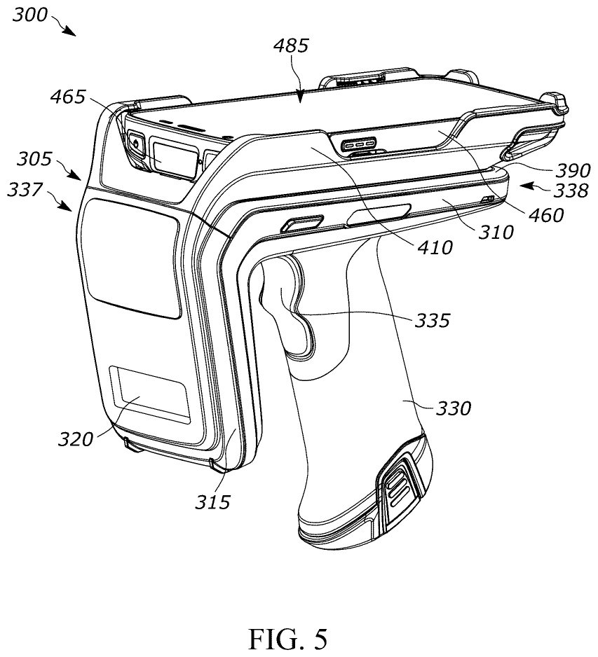

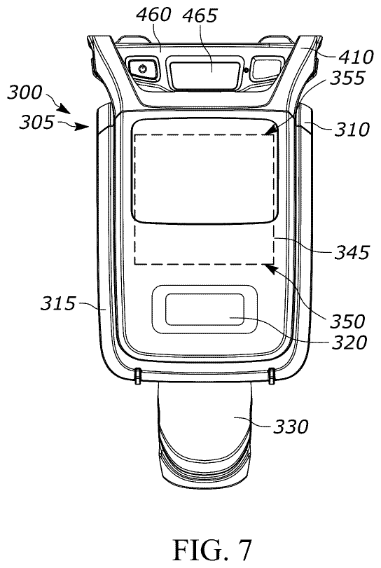

Referring to FIGS. 5-7, an example of a system 300 for reading RFID tags is illustrated. In the example shown, system 300 generally includes a housing 305 and a mobile computing device 460 removably mounted to housing 305. Housing 305 generally includes a top portion 310, a front portion 315 (e.g., an antenna dome, a.k.a. radome), and a handle 330 that extends from top portion 310. Front portion 315 can extend in a downward direction from top portion 310 (e.g., in the same direction as handle 330) and an RFID antenna 345 is positioned within front portion 315. Handle 330 is configured to be grasped by a user of system 300 and can include a trigger 335, which can be used to activate RFID antenna 345 and/or one or more imaging assemblies associated with system 300. Mobile computing device 460 can be any type of mobile computing device, for example, a smart phone or other type of mobile computer, which can have a processor, a memory, a display, an input device, etc. In the implementation shown, mobile computing device 460 includes a display 485 (see, e.g., FIG. 5), which can be oriented substantially parallel to a top surface 390 of housing 305 when mobile computing device 460 is mounted to housing 305. Display 485 can be a touchscreen, which is a display and an input device, or can be a display only and mobile computing device 460 can include a separate input device (e.g., a physical keyboard).

System 300 also includes a first imaging assembly 360 and a second imaging assembly 470. First imaging assembly 360 is located within housing 305, is positioned on a first side 350 of RFID antenna 345 and distal to top portion 310, and has a first FOV 365 that is directed through a first window 320 in front portion 315 of housing 305. Second imaging assembly 470 is located within mobile computing device 460, is located on a second side 355 of RFID antenna 345, opposite first side 350, with mobile computing device 460 mounted to housing 305. Second imaging assembly 470 has a second FOV 475 that is directed through a second window 465 in mobile computing device 460.

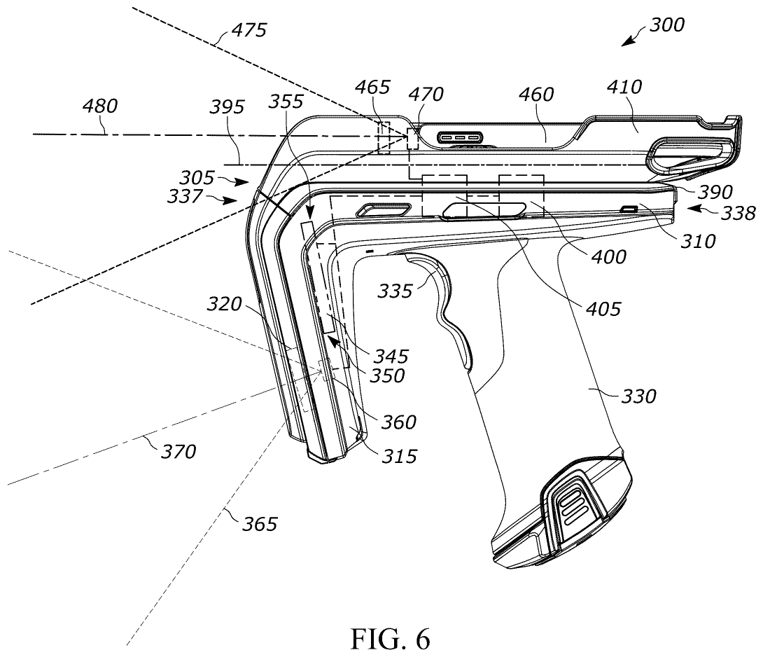

In the example shown, first FOV 365 has a first centerline 370 that extends non-parallel to a longitudinal axis 395 of housing 305 and in a direction away from a top surface 390 of housing 305 (e.g., downward in the orientation shown in FIG. 6) and second FOV 475 can have a second centerline 480 that extends generally parallel to longitudinal axis 395 of housing 305 with mobile computing device 460 mounted to housing 305. With first FOV 365 and second FOV 475 oriented in this manner, second FOV 475 can capture image data of objects generally aligned along longitudinal axis 395 of housing 305 and above RFID antenna 345 and first FOV 365 can capture image data of objects generally below RFID antenna 345 (e.g., a barcode located below an RFID tag or an object directly in front of system 300 with system 300 tilted in an upward direction). Additional configurations of first FOV 365 and second FOV 475 are also possible. For example, first FOV 365 and second FOV 475 can at least partially overlap at a predetermined distance in front of housing 305 with mobile computing device 460 mounted to housing 305, first FOV 365 can be configured to overlap or encompass a radiation pattern (not shown) of RFID antenna 345, centerlines can be directed in a desired direction, etc.

In implementations where first imaging assembly 360 is positioned proximate to RFID antenna 345, RFID antenna 345 may be designed in a manner that takes this adjacency into account to mitigate potential negative effect on the functional performance of RFID antenna 345. For example, the presence of first imaging assembly 360 may otherwise alter the resonant frequency, bandwidth, impedance, radiation pattern, gain, and/or directivity of RFID antenna 345. In a further example, the presence of first imaging assembly 360 may act as a capacitive load or an inductive load to RFID antenna 345, thereby shifting the resonant frequency of RFID antenna 345. As such, understanding that the elements of the immediate environment surrounding RFID antenna 345 may affect RFID antenna 345, the physical design of RFID antenna 345 can compensate for these loads by, for example, tailoring the geometry of physical features of an element(s) of the antenna (e.g., by lengthening or shortening) to optimally match the radiating frequency of RFID antenna 345 to the desired RFID band (i.e., tuning). For example, if it is known that the presence of a relatively close first imaging assembly 360 would pull the resonant frequency of RFID antenna 345 down, RFID antenna 345 may be designed with a shorter radiating element to counter this effect and bring the resonant frequency back up so that it is in the desired band. In another example, if it is known that the presence of first imaging assembly 360 below RFID antenna 345 pulls the radiation pattern of RFID antenna 345 downward, RFID antenna 345 and/or its immediate environment may include another conductive feature on the opposite side (e.g., second side 355) that counters this effect and pulls the radiation pattern back upward to center it. Furthermore, electrical connections directed to first imaging assembly 360 may be run in relatively close proximity to RFID antenna 345, and RFID antenna 345 can be configured to avoid interference from first imaging assembly 360. For example, RFID antenna 345 can be positioned and oriented within front portion 315 of housing 305 such that a communications bus connecting first imaging assembly 360 to other components of system 300 is located behind a ground plane of RFID antenna 345, where the communications bus can be effectively shielded from negatively affecting the performance of RFID antenna 345. Conversely, shielding the communications bus behind an antenna ground plane may also prevent RFID antenna 345 from interfering with the communications bus as well. In other embodiments, the communications bus may be treated as being in relatively close proximity to RFID antenna 345, and as such, RFID antenna 345 may be designed to take this into account as described earlier in order to mitigate any potential negative effect on the functional performance of RFID antenna 345.

In the implementation shown, system 300 includes a mounting adapter 410 that is configured to receive mobile computing device 460. In the implementation shown, mounting adapter 410 is removably mounted to top surface 390 of housing 305, for example, via spring arms on mounting adapter 410 that can engage a portion of housing 305, threaded members that can be threaded through mounting adapter 410 and into housing 305, a hook and loop type fastener located between mounting adapter 410 and housing 305, etc. In other implementations, mounting adapter 410 may not be a separate part and can be an integral and unitary part of housing 305.

As shown in the example in FIG. 6, system 300 can also include an accelerometer 400 positioned within housing 305 and configured to detect an angular orientation of housing 305. System 300 can also include a controller 405, which can include a processor and memory, that is in communication with accelerometer 400, first imaging assembly 360, and second imaging assembly 470. In some implementations, controller 405 can be configured to activate at least one of first imaging assembly 360 and/or second imaging assembly 470 based on the angular orientation of housing 305. For example, in response to the angular orientation of housing 305 indicating that system 300 is generally level or pointed in a downward direction relative to horizontal (e.g., as detected by accelerometer 400), controller 405 can be configured to activate at least second imaging assembly 470. Similarly, in response to the angular orientation of housing 305 indicating that system 300 is pointed in an upward direction relative to horizontal (e.g., as detected by accelerometer 400), controller 405 can be configured to activate at least first imaging assembly 360. As used herein, pointed in a downward direction relative to horizontal means that a first end 337 of housing 305, proximate front portion 315, is lower than a second end 338 of housing 305, distal from front portion 315. In addition, pointed in an upward direction relative to horizontal means that first end 337 is higher than second end 338, such as with system 300 tilted upward, such that a user can view display 485 of mobile computing device 460 with mobile computing device 460 mounted to housing 305.

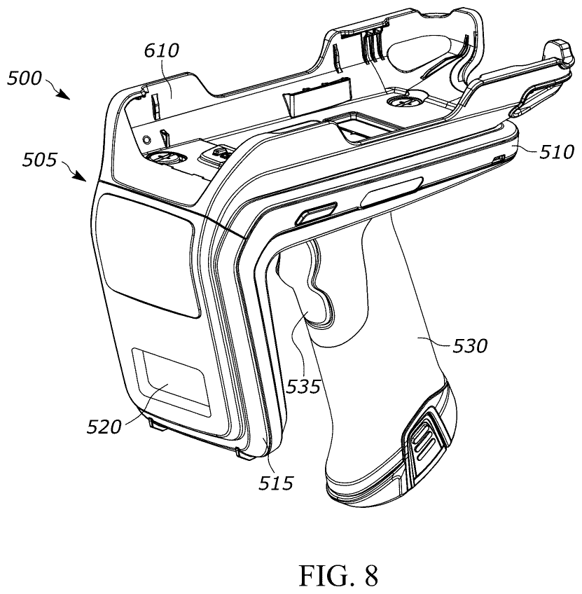

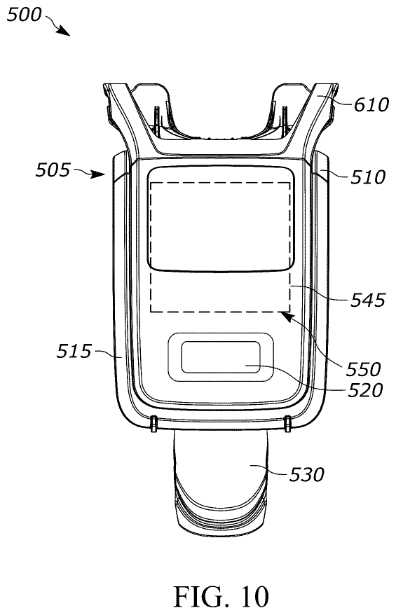

Referring to FIGS. 8-10, a second example of a hand-held accessory 500 for reading RFID tags is illustrated. In the example shown, hand-held accessory 500 generally includes a housing 505 including a top portion 510, a front portion 515 (e.g., an antenna dome, a.k.a. radome), and a handle 530 extending from top portion 510. Top portion 510 has a top surface 590 that is configured to receive a mobile computing device (not shown), which can be any type of mobile computing device, for example, a smart phone or other type of mobile computer, which can have a processor, a memory, a display, an input device, etc. Front portion 515 can extend in a downward direction from top portion 510 (e.g., in the same direction as handle 530), can include a first window 520, and can have an RFID antenna 545 positioned within front portion 515. Handle 330 is configured to be grasped by a user of hand-held accessory 500 and can include a trigger 535, which can be used to activate RFID antenna 545 and/or one or more imaging assemblies associated with the hand-held accessory 500.

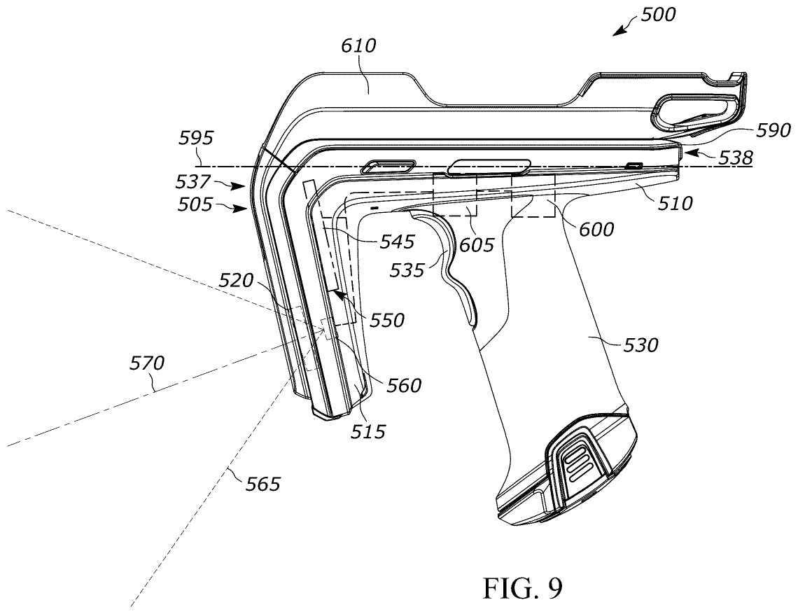

Hand-held accessory 500 also includes a first imaging assembly 560 that is located within housing 505, is positioned on a first side 550 of RFID antenna 545, opposite top surface 590, and distal to top portion 510 of housing 505, and has a first FOV 565 that is directed through first window 520 in front portion 515 of housing 505. In the example shown, first FOV 565 has a first centerline 570 that extends non-parallel to a longitudinal axis 595 of housing 505 and in a direction away from top surface 590 of housing 505 (e.g., downward in the orientation shown in FIG. 9). With first FOV 565 oriented in this manner, first FOV 565 can capture image data of objects generally below RFID antenna 545 (e.g., a barcode located below an RFID tag or an object directly in front of hand-held accessory 500 with hand-held accessory 500 tilted in an upward direction). Additional configurations of first FOV 565 are also possible. For example, first FOV 565 can be configured to overlap or encompass a radiation pattern (not shown) of RFID antenna 545, etc.

In implementations where first imaging assembly 560 is positioned proximate to RFID antenna 545, RFID antenna 545 may be designed in a manner that takes this adjacency into account to mitigate potential negative effect on the functional performance of RFID antenna 545. For example, the presence of first imaging assembly 560 may otherwise alter the resonant frequency, bandwidth, impedance, radiation pattern, gain, and/or directivity of RFID antenna 545. In a further example, the presence of first imaging assembly 560 may act as a capacitive load or an inductive load to RFID antenna 545, thereby shifting the resonant frequency of RFID antenna 545. As such, understanding that the elements of the immediate environment surrounding RFID antenna 545 may affect RFID antenna 545, the physical design of RFID antenna 545 can compensate for these loads by, for example, tailoring the geometry of physical features of an element(s) of the antenna (e.g., by lengthening or shortening) to optimally match the radiating frequency of RFID antenna 545 to the desired RFID band (i.e., tuning). For example, if it is known that the presence of a relatively close first imaging assembly 560 would pull the resonant frequency of RFID antenna 545 down, RFID antenna 545 may be designed with a shorter radiating element to counter this effect and bring the resonant frequency back up so that it is in the desired band. In another example, if it is known that the presence of first imaging assembly 560 below RFID antenna 545 pulls the radiation pattern of RFID antenna 545 downward, RFID antenna 545 and/or its immediate environment may include another conductive feature on the opposite side (e.g., second side 555) that counters this effect and pulls the radiation pattern back upward to center it. Furthermore, electrical connections directed to first imaging assembly 560 may be run in relatively close proximity to RFID antenna 545, and RFID antenna 545 can be configured to avoid interference from first imaging assembly 560. For example, RFID antenna 545 can be positioned and oriented within front portion 515 of housing 505 such that a communications bus connecting first imaging assembly 560 to other components of hand-held accessory 500 is located behind a ground plane of RFID antenna 545, where the communications bus can be effectively shielded from negatively affecting the performance of RFID antenna 545. Conversely, shielding the communications bus behind an antenna ground plane may also prevent RFID antenna 545 from interfering with the communications bus as well. In other embodiments, the communications bus may be treated as being in relatively close proximity to RFID antenna 545, and as such, RFID antenna 545 may be designed to take this into account as described earlier in order to mitigate any potential negative effect on the functional performance of RFID antenna 545.

In the implementation shown, hand-held accessory 500 also includes a mounting adapter 610 that is configured to receive a mobile computing device (not shown). In the implementation shown, mounting adapter 610 is removably mounted to top surface 590 of housing 505, for example, via spring arms on mounting adapter 610 that can engage a portion of housing 505, threaded members that can be threaded through mounting adapter 610 and into housing 505, a hook and loop type fastener located between mounting adapter 610 and housing 505, etc. In other implementations, mounting adapter 610 may not be a separate part and can be an integral and unitary part of housing 505.

As shown in the example in FIG. 9, hand-held accessory 500 can also include an accelerometer 600 positioned within housing 505 and configured to detect an angular orientation of housing 505. Hand-held accessory 500 can also include a controller 605, which can include a processor and memory, that is in communication with accelerometer 600 and first imaging assembly 560. In some implementations, controller 605 can be configured to activate first imaging assembly 560 based on the angular orientation of housing 505. For example, in response to the angular orientation of housing 505 indicating that hand-held accessory 500 is pointed in an upward direction relative to horizontal (e.g., as detected by accelerometer 600), controller 605 can be configured to activate at least first imaging assembly 560. As used herein, pointed in an upward direction relative to horizontal means that a first end 537 of housing 505, proximate front portion 515, is higher than a second end 538 of housing 505, distal from front portion 515, such as with hand-held accessory 500 tilted upward so that a user can view a display of a mobile computing device mounted to housing 505 in mounting adapter 610.

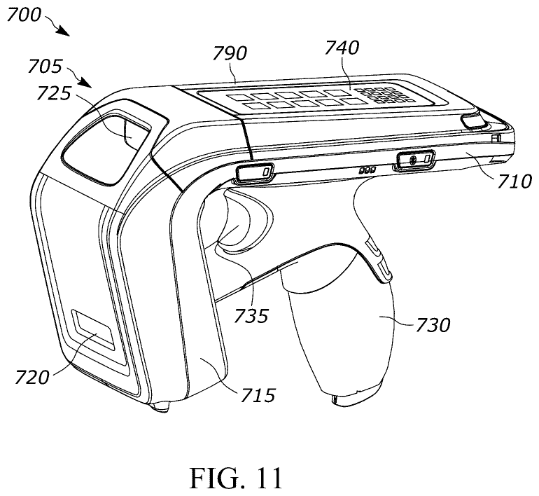

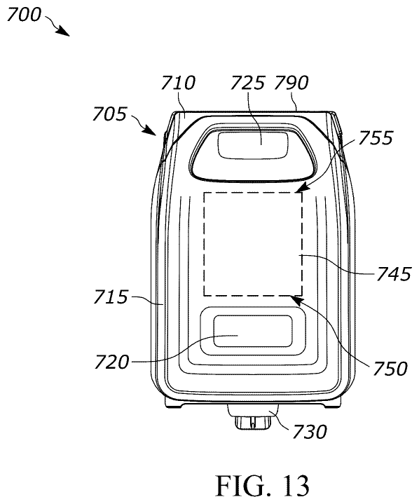

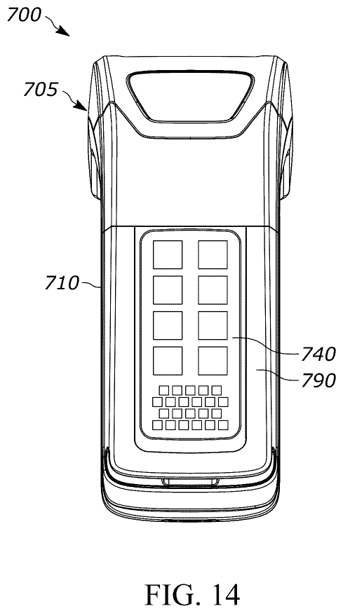

Referring to FIGS. 11-14, an example of a hand-held device 700 for reading RFID tags is illustrated. In the example shown, hand-held device 700 generally includes a housing 705, which includes a top portion 710, a front portion 715 (e.g., an antenna dome, a.k.a. radome), and a handle 730 that extends from top portion 710. Front portion 715 can extend in a downward direction from top portion 710 (e.g., in the same direction as handle 730) and an RFID antenna 745 is positioned within front portion 715. Handle 730 is configured to be grasped by a user of hand-held device 700 and can include a trigger 735, which can be used to activate RFID antenna 745 and/or one or more imaging assemblies associated with the hand-held device 700.

Hand-held device 700 also includes a first imaging assembly 760 and a second imaging assembly 775. First imaging assembly 760 is positioned on a first side 750 of RFID antenna 745 and distal to top portion 710 of housing 705 and has a first FOV 765 that is directed through a first window 720 in front portion 715 of housing 705. Second imaging assembly 775 is positioned on a second side 755 of RFID antenna 745, opposite first side 750, and proximal top portion 710 of housing 705 and has a second FOV 780 that is directed through a second window 725 in front portion 715 of housing 705.

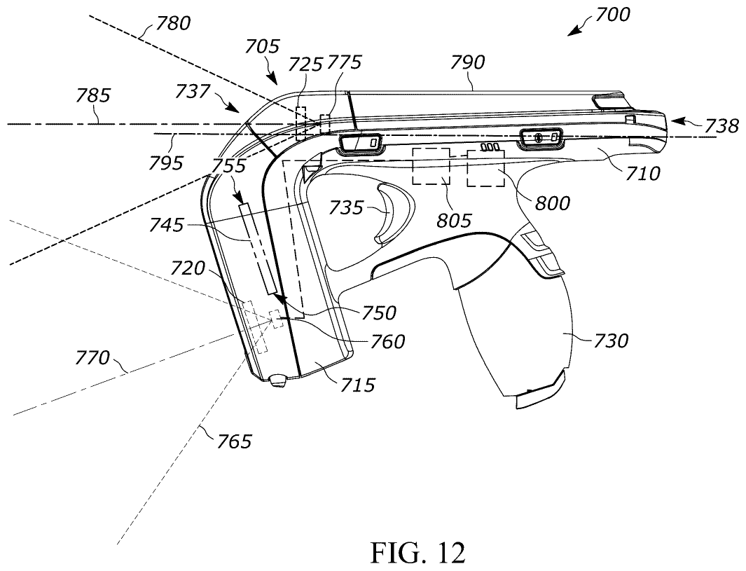

In the example shown, first FOV 765 has a first centerline 770 that extends non-parallel to a longitudinal axis 795 of housing 705 and in a direction away from a top surface 790 of housing 705 (e.g., downward in the orientation shown in FIG. 12) and second FOV 780 can have a second centerline 785 that extends generally parallel to longitudinal axis 795 of housing 705. With first FOV 765 and second FOV 780 oriented in this manner, second FOV 780 can capture image data of objects generally aligned along longitudinal axis 795 of housing 705 and above RFID antenna 745 and first FOV 765 can capture image data of objects generally below RFID antenna 745 (e.g., a barcode located below an RFID tag or an object directly in front of hand-held device 700 with hand-held device 700 tilted in an upward direction). Additional configurations of first FOV 765 and second FOV 780 are also possible. For example, first FOV 765 and second FOV 780 can partially overlap at a predetermined distance in front of housing 705, first FOV 765 can be configured to overlap or encompass a radiation pattern (not shown) of RFID antenna 745, etc.

In implementations where first imaging assembly 760 is positioned proximate to RFID antenna 745, RFID antenna 745 may be designed in a manner that takes this adjacency into account to mitigate potential negative effect on the functional performance of RFID antenna 745. For example, the presence of first imaging assembly 760 may otherwise alter the resonant frequency, bandwidth, impedance, radiation pattern, gain, and/or directivity of RFID antenna 745. In a further example, the presence of first imaging assembly 760 may act as a capacitive load or an inductive load to RFID antenna 745, thereby shifting the resonant frequency of RFID antenna 745. As such, understanding that the elements of the immediate environment surrounding RFID antenna 745 may affect RFID antenna 745, the physical design of RFID antenna 745 can compensate for these loads by, for example, tailoring the geometry of physical features of an element(s) of the antenna (e.g., by lengthening or shortening) to optimally match the radiating frequency of RFID antenna 745 to the desired RFID band (i.e., tuning). For example, if it is known that the presence of a relatively close first imaging assembly 760 would pull the resonant frequency of RFID antenna 745 down, RFID antenna 745 may be designed with a shorter radiating element to counter this effect and bring the resonant frequency back up so that it is in the desired band. In another example, if it is known that the presence of first imaging assembly 760 below RFID antenna 745 pulls the radiation pattern of RFID antenna 745 downward, RFID antenna 745 and/or its immediate environment may include another conductive feature on the opposite side (e.g., second side 755) that counters this effect and pulls the radiation pattern back upward to center it. Furthermore, electrical connections directed to first imaging assembly 760 may be run in relatively close proximity to RFID antenna 745, and RFID antenna 745 can be configured to avoid interference from first imaging assembly 760. For example, RFID antenna 745 can be positioned and oriented within front portion 715 of housing 705 such that a communications bus connecting first imaging assembly 760 to other components of hand-held device 700 is located behind a ground plane of RFID antenna 745, where the communications bus can be effectively shielded from negatively affecting the performance of RFID antenna 745. Conversely, shielding the communications bus behind an antenna ground plane may also prevent RFID antenna 745 from interfering with the communications bus as well. In other embodiments, the communications bus may be treated as being in relatively close proximity to RFID antenna 745, and as such, RFID antenna 745 may be designed to take this into account as described earlier in order to mitigate any potential negative effect on the functional performance of RFID antenna 745.

Hand-held device 700 can also include an input-output device 740 positioned at least partially within housing 705, for example, at least partially positioned in top portion 710 of housing 705. In the implementation shown, input-output device 740 is a touchscreen, but could be a display and a separate keyboard or any other appropriate device to display information to a user of hand-held device 700 and allow the user to input data.

As shown in the example in FIG. 12, hand-held device 700 can also include an accelerometer 800 positioned within housing 705 and configured to detect an angular orientation of housing 705. Hand-held device 700 can also include a controller 805, which can include a processor and memory, in communication with accelerometer 800, first imaging assembly 760, second imaging assembly 775, and input-output device 740. In some implementations, controller 805 can be configured to activate at least one of first imaging assembly 760 and/or second imaging assembly 775 based on the angular orientation of housing 705. For example, in response to the angular orientation of housing 705 indicating that hand-held device 700 is generally level or pointed in a downward direction relative to horizontal (e.g., as detected by accelerometer 800), controller 805 can be configured to activate at least second imaging assembly 775. Similarly, in response to the angular orientation of housing 705 indicating that hand-held device 700 is pointed in an upward direction relative to horizontal (e.g., as detected by accelerometer 800), controller 805 can be configured to activate at least first imaging assembly 760. As used herein, pointed in a downward direction relative to horizontal means that a first end 737 of housing 705, proximate front portion 715, is lower than a second end 738 of housing 705, distal from front portion 715. In addition, pointed in an upward direction relative to horizontal means that first end 737 is higher than second end 738, such as with hand-held device 700 tilted upward, such that a user can view input-output device 740. In some implementations, controller 805 sends accelerometer 800 based information to the input-output device 740, such as the current orientation (e.g., tilt angles) of the hand-held device 700, which may be displayed to the user.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter.

1. A hand-held accessory for reading radio-frequency identification (RFID) tags, comprising:
a housing including a top portion, a front portion, and a handle, the front portion having a first window and a second window and the handle extending from the top portion;
an RFID antenna positioned within the front portion of the housing;
a first imaging assembly positioned on a first side of the RFID antenna and distal to the top portion of the housing, the first imaging assembly having a first field-of-view (FOV) directed through the first window; and
a second imaging assembly positioned on a second side of the RFID antenna and proximal the top portion of the housing, the first side being opposed to the second side, the second imaging assembly having a second FOV directed through the second window.

2. The hand-held accessory of claim 1, comprising a mounting adapter removably mounted to a top surface of the housing and configured to receive a mobile computing device.

3. The hand-held accessory of claim 1, wherein
the first FOV and the second FOV at least partially overlap;
a first centerline of the first FOV extends non-parallel to a longitudinal axis of the housing and in a direction away from a top surface of the housing; and
a second centerline of the second FOV extends parallel to the longitudinal axis of the housing.

4. The hand-held accessory of claim 1, comprising an accelerometer positioned within the housing and configured to detect an angular orientation of the housing.

5. The hand-held accessory of claim 4, comprising a controller in communication with the first imaging assembly, the second imaging assembly, and the accelerometer, wherein the controller is configured to:
activate at least one of the first imaging assembly and/or the second imaging assembly based on the angular orientation of the housing; and
responsive to the angular orientation of the housing indicating that the hand-held accessory is pointed in a downward direction relative to horizontal, activate at least the second imaging assembly; and
responsive to the angular orientation of the housing indicating that the hand-held accessory is pointed in an upward direction relative to horizontal, activate at least the first imaging assembly.

6. The hand-held accessory of claim 1, wherein the RFID antenna is configured to avoid interference from the first imaging assembly.

7. A system for reading radio-frequency identification (RFID) tags, comprising:
a housing including a top portion, a front portion, and a handle, the front portion having a first window and the handle extending from the top portion;
an RFID antenna positioned within the front portion of the housing;
a first imaging assembly positioned on a first side of the RFID antenna and distal to the top portion of the housing, the first imaging assembly having a first field-of-view (FOV) directed through the first window; and
a mobile computing device removably mounted to the housing, the mobile computing device comprising: a second window; and second imaging assembly having a second FOV directed through the second window, the second imaging assembly located on a second side of the RFID antenna, the first side being opposed to the second side, with the mobile computing device mounted to the housing.

8. The system of claim 7, wherein the mobile computing device includes a display, the display being oriented substantially parallel to a top surface of the housing with the mobile computing device mounted to the housing.

9. The system of claim 7, comprising a mounting adapter removably mounted to a top surface of the housing and configured to receive the mobile computing device.

10. The system of claim 7, wherein
the first FOV and the second FOV at least partially overlap;
a first centerline of the first FOV extends non-parallel to a longitudinal axis of the housing and in a direction away from a top surface of the housing; and
a second centerline of the second FOV extends parallel to the longitudinal axis of the housing.

11. The system of claim 7, comprising an accelerometer positioned within the housing and configured to detect an angular orientation of the housing.

12. The system of claim 11, comprising a controller in communication with the first imaging assembly, the second imaging assembly, and the accelerometer, wherein the controller is configured to:
activate at least one of the first imaging assembly and/or the second imaging assembly based on the angular orientation of the housing; and
responsive to the angular orientation of the housing indicating that the system is pointed in a downward direction relative to horizontal, activate at least the second imaging assembly; and
responsive to the angular orientation of the housing indicating that the system is pointed in an upward direction relative to horizontal, activate at least the first imaging assembly.

13. The system of claim 7, wherein the RFID antenna is configured to avoid interference from the first imaging assembly.

14. A hand-held accessory for reading radio-frequency identification (RFID) tags, comprising:
a housing including a top portion, a front portion, and a handle, the front portion having a first window and the top portion having a top surface configured to receive a mobile computing device and the handle extending from the top portion;
an RFID antenna positioned within the front portion of the housing; and
a first imaging assembly positioned on a first side of the RFID antenna, and distal to the top portion of the housing, the first side being opposite the top surface, the first imaging assembly having a first field-of-view (FOV) directed through the first window.

15. The hand-held accessory of claim 14, comprising a mounting adapter removably mounted to the top surface of the housing and configured to receive the mobile computing device.

16. The hand-held accessory of claim 14, wherein a first centerline of the first FOV extends non-parallel to a longitudinal axis of the housing and in a direction away from the top surface of the housing.

17. The hand-held accessory of claim 14, comprising an accelerometer positioned within the housing and configured to detect an angular orientation of the housing.

18. The hand-held accessory of claim 17, comprising a controller in communication with the first imaging assembly and the accelerometer, wherein the controller is configured to:
activate the first imaging assembly based on the angular orientation of the housing; and
responsive to the angular orientation of the housing indicating that the hand-held accessory is pointed in an upward direction relative to horizontal, activate at least the first imaging assembly.

19. The hand-held accessory of claim 14, wherein the RFID antenna is configured to avoid interference from the first imaging assembly.

20. A hand-held device for reading radio-frequency identification (RFID) tags, comprising:
a housing including top portion, a front portion, and a handle, the front portion having a first window and a second window and the handle extending from the top portion;
an input-output device positioned at least partially within the housing;
an RFID antenna positioned within the front portion of the housing;
a first imaging assembly positioned on a first side of the RFID antenna and distal to the top portion of the housing, the first imaging assembly having a first field-of-view (FOV) directed through the first window; and
a second imaging assembly positioned on a second side of the RFID antenna and proximal the top portion of the housing, the first side being opposed to the second side, the second imaging assembly having a second FOV directed through the second window.

21. The hand-held device of claim 20, wherein
the input-output device is at least partially positioned in the top portion of the housing; and
the input-output device comprises one or more of a touchscreen, a display, and a keyboard.

22. The hand-held device of claim 20, wherein
the first FOV and the second FOV at least partially overlap;
a first centerline of the first FOV extends non-parallel to a longitudinal axis of the housing and in a direction away from a top surface of the housing; and
a second centerline of the second FOV extends parallel to the longitudinal axis of the housing.

23. The hand-held device of claim 20, comprising an accelerometer positioned within the housing and configured to detect an angular orientation of the housing.

24. The hand-held device of claim 23, comprising a controller in communication with the first imaging assembly, the second imaging assembly, the input-output device and the accelerometer, wherein the controller is configured to:
activate at least one of the first imaging assembly and/or the second imaging assembly based on the angular orientation of the housing; and
responsive to the angular orientation of the housing indicating that the hand-held device is pointed in a downward direction relative to horizontal, activate at least the second imaging assembly; and
responsive to the angular orientation of the housing indicating that the hand-held device is pointed in an upward direction relative to horizontal, activating at least the first imaging assembly.

25. The hand-held device of claim 20, wherein the RFID antenna is configured to avoid interference from the first imaging assembly.
